(19) United States
(12) Patent Application Publication
(10) Pub. No.: US 2016/0132903 A1
(43) Pub. Date: May 12, 2016

(54) IDENTIFYING AN INDUSTRY SPECIFIC E-MAVEN

(71) Applicant: Tata Consultancy Services Limited, Mumbai (IN)

(72) Inventors: Vandita Bansal, Bangalore (IN); Rajarajan T. R., Bangalore (IN); Mani Kanteswara Rao Garlapati, Bangalore (IN)

(21) Appl. No.: 14/860,077

(22) Filed: Sep. 21, 2015

(30) Foreign Application Priority Data
Nov. 11, 2014 (IN) 3599/MUM/2014

(51) Int. Cl. G06Q 30/02; G06Q 50/00

(52) U.S. Cl. CPC G06Q 30/0201; G06Q 50/01

(57) ABSTRACT

Disclosed is a method and system for identifying an industry specific e-maven by analyzing textual data from social media. The system may collect textual data posted by users on social media. The system may then determine characteristics of the users by analyzing the textual data. The system may further calculate a maven score for the users by using the characteristics. The system may compute an industrial maven score for the users by using the maven scores and an industry adjustment factor. An industry specific e-maven may thus be identified based on the industry adjustment factor.

### CROSS-REFERENCE TO RELATED APPLICATIONS AND PRIORITY

The present application claims priority to a Patent Application Serial Number 3599/MUM/2014 filed before the Indian Patent Office on Nov. 11, 2014, which is incorporated herein by reference in its entirety.

### TECHNICAL FIELD

The present subject matter described herein, in general, relates to identifying e-mavens for any specific industry or brands.

### BACKGROUND

Several companies are constantly endeavoring to devise innovative ways of advertising their products and services. One of the ways is to use social media in innovative ways to promote such products or services. These products and services are generally more acceptable to people on social media when referred by their connections. The social media users referring brand/industry/product on the social media may be identified as e-mavens, mavens, knowledge spreaders, social influencers, information spreaders, market mavens, market connoisseurs, and market diffusers.

Precisely identifying the e-mavens on the social media is a recent practice used for advertisement. The e-mavens may be identified precisely upon analyzing data of the social media users from the social media. The data may comprise of posts uploaded by the social media users, likes and comments on posts uploaded by friends. The data may be analyzed for learning about the social media users.

Further, identifying the e-mavens based only on an activity of the social media users on the social media may not always be a perfect approach. This approach may not consider an industry relevance of the social media users. The e-mavens thus identified, may always not spread a positive word about the brand/industry/product not related to the e-mavens.

### SUMMARY

This summary is provided to introduce aspects related to systems and methods for identifying an industry specific e-maven by analyzing textual data from social media and the aspects are further described below in the detailed description. This summary is not intended to identify essential features of the claimed subject matter nor is it intended for use in determining or limiting the scope of the claimed subject matter.

In one implementation, a method for identifying an industry specific e-maven by analyzing textual data from social media is disclosed. The method may comprise, collecting textual data posted by users on social media. The textual data may be collected using an industrial corpus. The industrial corpus may comprise a collection of industry specific keywords. The method may comprise determining characteristics of the users by analyzing the textual data. The textual data may be analyzed using an adaptively self-learning database. The characteristics of the user may comprise socio-networking characteristics, socio-behavioral characteristics, and psychometric characteristics. The method may further comprise calculating maven scores for the users. The maven scores may be calculated based on the scores for each characteristic of the users. The method may further comprise calculating industrial maven scores for the users by using the maven scores and an industry adjustment factor. The method may further comprise identifying at least an industry specific e-maven based on the industrial maven scores.

In one implementation, a system for identifying an industry specific e-maven by analyzing textual data from social media is disclosed. The system may comprise a processor and a memory coupled to the processor for executing programmed instructions stored in the memory. The processor may collect textual data posted by users on social media. The textual data may be collected using an industrial corpus. The industrial corpus may comprise a collection of industry specific keywords. The processor may further determine characteristics of the users by analyzing the textual data. The textual data may be analyzed using an adaptively self-learning database. The characteristics of the users may comprise socio-networking characteristics, socio-behavioral characteristics, and psychometric characteristics. The processor may further calculate maven scores for the users based on the characteristics of the users. The processor may further calculate industrial maven scores for the users by using the maven scores and an industry adjustment factor. The processor may further identify at least an industry specific e-maven based on the industrial maven scores.

In one implementation, a non-transitory computer readable medium embodying a program executable in a computing device for identifying an industry specific e-maven by analyzing textual data from social media is disclosed. The program may comprise a program code for collecting textual data posted by users on social media. The textual data may be collected using an industrial corpus. The industrial corpus may comprise a collection of industry specific keywords. The program may further comprise a program code for determining characteristics of the users by analyzing the textual data. The textual data may be analyzed using an adaptively self-learning database. The characteristics of the users may comprise socio-networking characteristics, socio-behavioral characteristics, and psychometric characteristics. The program may further comprise a program code for calculating maven scores for the users based on the characteristics of the users. The program may further comprise a program code for calculating industrial maven scores for the user by using the maven scores and an industry adjustment factor. The program may further comprise a program code for identifying at least an industry specific e-maven based on the industrial maven scores.

### BRIEF DESCRIPTION OF THE DRAWINGS

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates a network implementation of a system for identifying an industry specific e-maven, in accordance with an embodiment of the present subject matter.

FIG. 2 illustrates the system for identifying an industry specific e-maven, in accordance with an embodiment of the present subject matter.

FIG. 3 illustrates a structured form of textual data derived from an unstructured form of textual data, in accordance with an embodiment of the present subject matter.

FIG. 4 shows a flowchart illustrating a method for identifying an industry specific e-maven, in accordance with an embodiment of the present subject matter.

### DETAILED DESCRIPTION

Systems and methods for identifying an industry specific e-maven by analyzing textual data from social media are described in the present subject matter. The system may collect textual data posted by users on social media. Though it should be appreciated that the social media users and users can be used interchangeably in the present invention. The system may collect the textual data using an industrial corpus. The industrial corpus may be programmed by an administrator to store industry specific keywords. The industry specific keywords may be related to a brand of product or service, a category of product or service, and industry jargons. The system may identify the industry specific keywords present the text posted by the users. Identifying the industry specific keywords may subsequently help the system in identifying an industry specific e-maven.

Further, the system may determine characteristics of the users. The system may analyze the textual data posted by the users for determining the characteristics of the users. The system may analyze the textual data using an adaptively self-learning database. Further, determining the characteristics may comprise determining socio-networking characteristics, socio-behavioral characteristics, and psychometric characteristics of the users.

Post determining the characteristics, the system may calculate maven scores for the user. The system may calculate the maven scores based on the characteristics of the users. The system may further calculate industrial maven scores using the maven scores and an industry adjustment factor. Finally, the system may identify at least an industry specific e-maven based on the industrial maven scores. In an example, users having highest industrial maven score may be identified by the system as the industry specific e-maven.

While aspects of described system and method for identifying an industry specific e-maven by analyzing textual data from social media may be implemented in any number of different computing systems, environments, and/or configurations, the embodiments are described in the context of the following exemplary system.

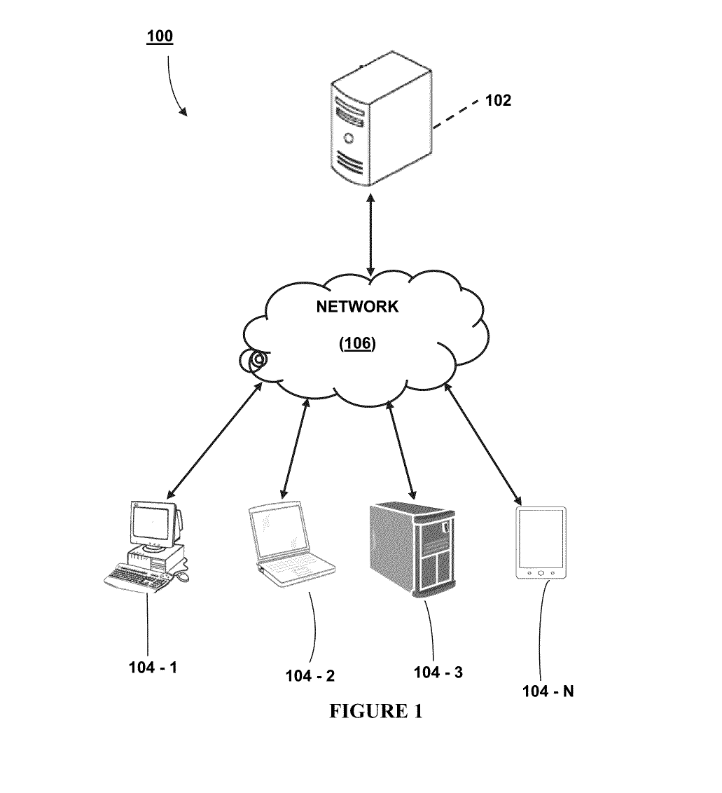

Referring now to FIG. 1, the system 102 for identifying an industry specific e-maven by analyzing textual data from social media is shown, in accordance with an embodiment of the present subject matter. Although the present subject matter is explained considering that the system 102 is implemented on a computer, it may be understood that the system 102 may also be implemented in a variety of computing systems including but not limited to, a smart phone, a tablet, a notepad, a personal digital assistant, a handheld device, a laptop computer, a notebook, a workstation, a mainframe computer, a server, and a network server. Further it should be appreciated that the system 102 can also identify the industry specific e-maven by analyzing other types of textual data such as pictorial textual data from the social media.

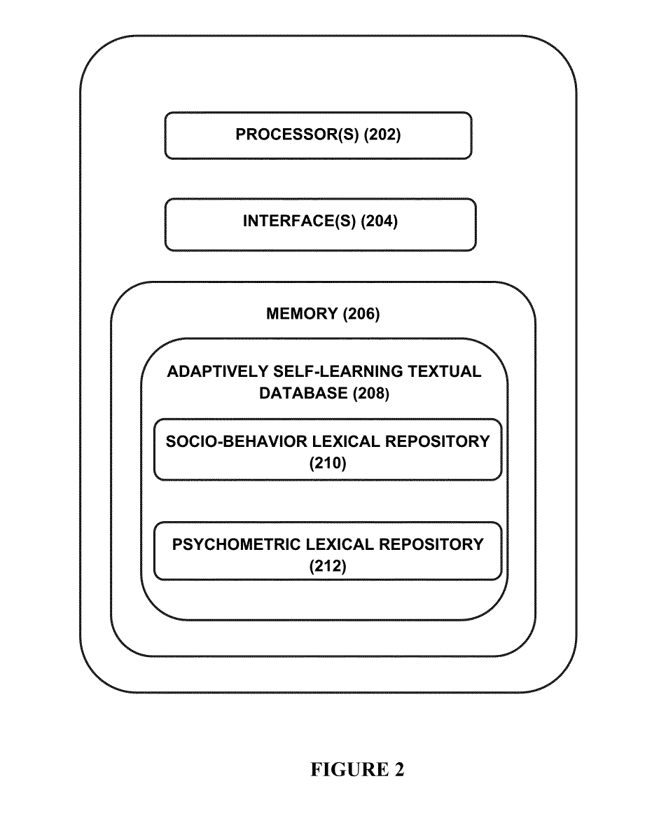

In one embodiment, as illustrated using FIG. 2, the system 102 may include at least one processor 202, a memory 206, and input/output (I/O) interfaces 204. Further, the at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 110 is configured to fetch and execute computer-readable instructions stored in the memory 206.

The I/O interfaces 204 may include a variety of software and hardware interfaces, for example, a web interface, a graphical user interface, and the like. The I/O interfaces 204 may allow the system 102 to interact with a user directly. Further, the I/O interfaces 204 may enable the system 102 to communicate with other computing devices, such as web servers and external data servers (not shown). The I/O interfaces 204 can facilitate multiple communications within a wide variety of networks and protocol types, including wired networks, for example, LAN, cable, etc., and wireless networks, such as WLAN, cellular, or satellite.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one implementation, the system 102 may collect textual data posted by users on social media. The textual data posted by the users, on the social media, are well known in the art as posts. The social media that may be used for collecting the textual data are FACEBOOK®, LINKEDIN®, TWITTER®, GOOGLE+®, and FLICKR® social networking online forums and other blogs and microblogs. The system 102 may collect the textual data using an industrial corpus. In a case, the industrial corpus may be a programmable database. The industrial corpus may be programmed by an administrator to store a set of keywords. The keywords may be industry specific and may be related to a brand of product or service, a category of product or service, and industry jargons. The industry specific keywords may be related to geography of interest for an industry. In an example, a cell phone manufacturer may be interested in identifying the e-mavens. The industrial corpus may then be programmed to store the keywords related to the cell phone industry. For an example, the keywords related to the cell phone industry may comprise cell phone, smart phone, mobile, and phablet. Further, the keywords related to different brands of cell phones and some models of the different brands may also be stored in the industrial corpus. Thus, the system 102 may scan for the industry specific keywords, using the industrial corpus, in the posts. Scanning for the industry specific keywords may help in identifying the posts relevant to a specific industry.

In one embodiment, the system 102 may scan for the industry specific keywords on a post of the user. The post of the user may be present on the FACEBOOK® social networking online forum. In an example, the post of the user may be “my smart phone now helps me to connect with my friends and family.” The system 102 may identify the keyword “smart phone” because smart phone represents a product and the keyword may already be stored on the industrial corpus.

Upon identifying the post of the user including the industry specific keywords, the system 102 may extract a user identification code (user ID). The system 102 may extract the user ID from information about the user. Post extracting the user ID, the system 102 may acquire entire textual data associated with the user ID of the user. The entire textual data may correspond to other posts of the user on same social website or on other social media websites used by the user. Further, the system 102 may collect a screen name of the user and social demographics of the users.

Post collecting the entire textual data, the system 102 may refine the entire textual data for removing stop words, tokenizing the textual data, and correcting spelling of the textual data. Subsequently, the system 102 may perform language style analysis and language content analysis of the entire textual data. The system 102 may perform the language style analysis for identifying different language fields. The different language fields may comprise a count statistics, pronouns, emotions, and grammar. The different language fields may be identified based on a set of parameters. In one embodiment, the set of parameters identified in the count statistics of the entire textual data are as follows.

Word Statistics

Total Number of words in a post
Average number of words in a sentence
Total number of question marks in a sentence
Frequency of use of exclamation marks
Vocabulary level of the individual (Total number of unique words used)

In one embodiment, pronouns associated with the entire textual data may be as follows.

Pronouns

Percentage of first person used
Percentage of third person used
Percentage of Second Person used
Percentage of Third Person used

In one embodiment, the set of parameters determined during grammar analysis of the entire textual data are as follows.

Grammar

Number of articles used
Number of punctuations used
Number of nouns referred
Percentage of verbs used

In one embodiment, types of emotions associated with the entire textual data may be identified as follows.

Emotions

Positive emotions
Optimism
Negative emotion
Anxiety
Anger

Post performing the language style analysis of the entire textual data, the system 102 may perform language content analysis of the entire textual data. Language content analysis of the entire textual data may be performed using the adaptively self-learning database 208. While performing the language content analysis using the adaptively self-learning database 208, the system 102 may determine characteristics of the users. The characteristics may comprise of three components. Specifically the three components being socio-networking characteristics, socio-behavioral characteristics, and psychometric characteristics of the user.

The system 102 may further determine the socio-behavioral characteristics of the user by using a socio-behavior lexical repository 210. The socio-behavior lexical repository 210 may comprise a socio-behavior seed word dictionary. The socio-behavior seed word dictionary may comprise a prestored set of seed words. Each set of the seed words may correspond to a socio-behavior characteristic. The system 102 may match keywords present in the entire textual data related to the users with seed words of the socio-behavior seed word dictionary. A section of the socio-behavior seed word dictionary comprising set of seed words, a socio-behavior characteristic corresponding to each set of the seed words, and a description of the socio-behavior characteristic is illustrated below.

| | Socio-Behavior | Description of the Socio- |
|---|---|---|
| Seed words | characteristics | Behavior characteristics |
| E.g. Seed for Retail | Industry specific interest | This is the interest area |
| Industry Shop, buy, | area (For e.g. Shopping for | pertaining to an industry |
| purchase, credit card, | the retail) | (For e.g. For travel industry |
| shopping list, malls, | | the area of interest will be |
| apparel, clothes, market | | travel, for a banking |
| | | industry it would be |
| | | “finance” etc. |
| Coupon, deal, offer, sale, | Smart shopper | They tend to use shopping |
| Discount | | list, use coupons and know |
| | | about sales |
| For example: products | Discuss variety of products | Provide information |
| across different categories | | regarding various kinds of |
| like grocery, cosmetics, | | products like high-tech |
| health related products | | products, durable/non- |
| | | durable products, service |
| | | quality, various dimensions |
| | | of the stores like store |
| | | layout, product quality, |
| | | service quality |
| Walmart, J C Penney, | High brand recall | They are aware of large |
| Samsung, Motorola, . . . etc. | | number of brands across all |
| | | product categories. |
| News, books, newspaper, | High media consumption | They have high tendency to |
| TV, Movies, Wall Street, | | read newspapers, |
| Good House Keeping, | | magazines, watch television |
| Vogue, Smart Photography | | and listen to radio. |
| Launch, upcoming, new | New product awareness | They know about new |
| product | | product launches. |

In an embodiment, the variables determined from the socio-behavioral characteristics of the users may be as follows:
Percentage of products/Brands related to the industry of interest
Total number of Brands/Products/New Products/New Brands/Deals
Percentage of posts talking about the Product/Brand/New Product/Deals
Occurrence of posts related to Brands/Products
Average Number of comments/retweets/likes received on the post related to the products, brand
Percentage of Posts talking about area of Interest
Average Comments received on Posts of Area of Interest
Percentage posts which talks about Radio/TV/Magazine/Books, and
Percentage of Posts with URL.

The system 102 may further determine the psychometric characteristics of the user by using a psychometric lexical repository 212. The psychometric lexical repository 212 may comprise a psychometric seed word dictionary. The psychometric seed word dictionary may comprise a prestored set of seed words. Each set of the seed words may correspond to a psychometric characteristic. The system 102 may match keywords present in the entire textual data related to the users with seed words of the psychometric seed word dictionary. Further, a section of the psychometric seed word dictionary comprising set of seed words, a psychometric characteristic corresponding to each set of the seed words, and a description regarding the psychometric characteristic is illustrated below.

| | Psychometric | Description of the Psychometric |
|---|---|---|
| Seed words | characteristics | characteristics |
| Help, kind, friend, charity | Altruistic | They like to help others by sharing |
| | | the information that they possess |
| Friends, restaurants, | Extrovert | They are outgoing and have large |
| movies, TV, game, food, | | social groups |
| drinks, shots | | |
| Believe, self-respect, | Self-confident | They have high self-esteem and are |
| confidence, know | | self-confident |
| Poetry, Philosophy, | Innovative/Openness | They tend to know about new |
| reason, logic, new idea, | | products, like to try new things in |
| explore | | general. |
| Logical, intelligent, | Need for high | They enjoy complex tasks and have |
| should, could, would, | cognition | a high need for cognition. They |
| reason, complex, | | tend to process a lot of information |
| | | before sharing it with others |
| Help, kind, friend, charity | Altruistic | They like to help others by sharing |
| | | the information that they possess |

In an embodiment, variables apart from the language fields derived during language style analysis may be derived. Cumulatively, the variables derived from the psychometric may be as mentioned below:
Word Statistics
Pronouns
Emotions
Grammar
Percentage of Posts which display Altruistic Characteristics
Percentage of Posts which display Open-Mindedness
Percentage of Posts which display Extraversion Characteristics
Percentage of Posts which display Self-Confidence, and
Percentage of Posts which display “High Cognition” Characteristics.

Further, the system 102 may also be connected to standard lexical databases available online over World Wide Web. In one embodiment, the system 102 may be connected to the standard lexical database like WORDNET™. The standard lexical database may help the system 102 in identifying words similar to the seed words i.e. synonyms of the seed words. In this manner, the standard lexical databases may augment word coverage of the socio-behavior seed word dictionary and the psychometric seed word dictionary and thus improvise the adaptively self-learning database (208). Thus, the adaptively self-learning database (208) learns and adapts in the above described manner.

While determining the socio-behavioral characteristics and psychometric characteristics of the users, the adaptively self-learning database 208 of the system 102 may come across a new topic or a new word. The new topic may not be already present in the adaptively self-learning database 208. During such a situation, the system 102 may communicate with a lexical database which may be available online over the World Wide Web. In one embodiment, the system 102 may communicate with the lexical database DBPEDIA™. The system 102 may communicate with DBPEDIA™ using WIKIPEDIA™ Application Programming Interfaces (API's). API's refer to a set of program instructions for performing a dedicated task. Using DBPEDIA™, the system 102 may classify the new word into one of predefined categories. The predefined categories used for classifying the new word may be related to characteristics of a name, place or a thing. A section illustrating the predefined categories for the text classification is as shown below.

| Characteristic | Category |
|---|---|
| Name | Sports, Movie, Music, Art, Politics, News, |
| | Literature, Historical Figure, |
| | Education, CEOs and Miscellaneous |
| Place | The name is associated with the place |
| Thing | Brand name or product falling in either of |
| | the verticals- Retail, Telecom, Energy, |
| | Manufacturing, Travel, Hospitality, Bank, |
| | Insurance, Pharma and Others. Book Name, |
| | Music Album, Music Name, Movies Name, |
| | Magazine Name, Newspaper Name |

Post determining the socio-behavioral characteristics and psychometric characteristics of the users, the system 102 may determine the socio-networking characteristics of the users. The system 102 may determine the socio-networking characteristics of the users from social network activity of the users. The parameters used for defining the social network activity/socio-networking characteristics of the users are as follows:
Number of friends/connections of the users
Number of followers of the users
Number of posts/tweets
Level of activity over past weeks
Activity consistency, and
Number of replies/mentions/comments/retweets.

Based on the language content analysis of the entire textual data, the system 102 may derive a structured set of textual data. The structured set of textual data may comprise a plurality of variables derived from the entire textual data present in an unstructured form. In one embodiment, the plurality of variables derived from the unstructured form of textual data are as follows:
Total number of mentions on TWITTER™
Total number of friends/followers
Total number of posts/blogs posted in a given time period
Average number of comments/retweets per post, message
Velocity of the posts
Percentage of products/Brands related to the industry of interest
Total number of Brands/Products/New Products/New Brands/Deals
Percentage of posts talking about the Product/Brand/New Product/Deals
Occurrence of posts related to Brands/Products
Average number of comments/retweets/likes received on the post related to the products, brand
Percentage of posts talking about area of Interest
Average comments received on Posts of Area of Interest
Percentage of posts talking about Radio/TV/Magazine/Books
Percentage of posts with URL
Percentage of posts displaying Altruistic characteristics
Percentage of posts displaying Open-Mindedness characteristics
Percentage of posts displaying Extraversion characteristics
Percentage of posts displaying Self-Confidence characteristics
Percentage of Posts displaying “High Cognition” characteristics
Percentage of Posts displaying “Need for uniqueness” characteristics.

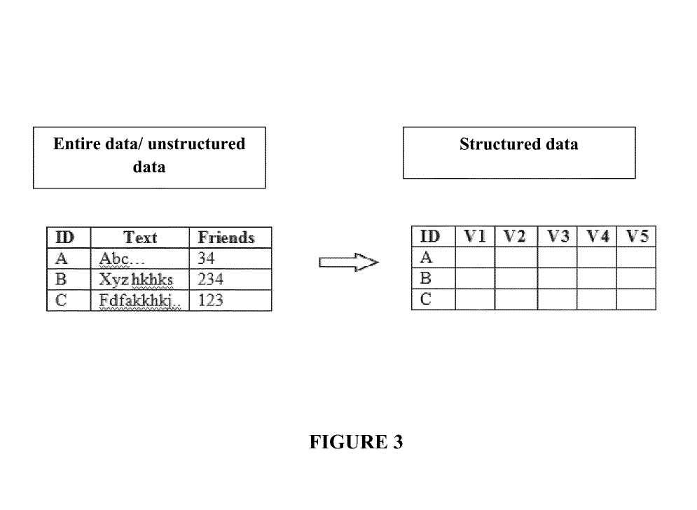

Post deriving the plurality of variables, the system 102 may store the plurality of variables against a corresponding user ID. This leads to the derivation of a structured form of textual data from an unstructured form of textual data. Further, FIG. 3 illustrates a sample of structured form of textual data comprising the plurality of variables (V1-V5) derived from the entire textual data present in an unstructured form.

After deriving the structured form of textual data, the system 102 may compute a maven score for the users. In one embodiment, the maven score may depend on number of connections of the users. The number of connections of the users may help in determining a reach of the users into the social media. Types of the connections that the users may have are primary connections, secondary connections, and tertiary connections. The primary connections may refer to friends present in a friend list of the users. The secondary connections may refer to friends of friends of the users. The tertiary connections may refer to persons viewing and/or commenting on the posts of the users and the persons may not be connected to the users. In one case, the primary connections of the user may only be considered for computing the interim maven score for the users. An increase in a number of the connections of the users may correspond to an increase in the interim maven score. Thus, an equation 1, as mentioned below, may be derived using the present relation.

Interim maven Score∝Number of connections (N) Equation 1

Further, a reach of the posts of the users may depend on a number of views of the posts of the users. The number of views of a post of a user may be determined based on a number of comments on the post, a number of likes for the post, and a number of retweets of the post. The number of views of the posts may help in determining a quality of the information provided by the users. Thus, equations 2, 3, 4, and 5 as mentioned below, may be used for calculating the interim maven score.

Interim maven score∝Number of product mentionŝ(Average number of comments+average number of likes+average number of retweets+posts velocity) Equation 2

Interim maven score∝Number of brand mentionŝ(Average number of comments+average number of likes+average number of retweets+posts velocity) Equation 3

Interim maven Score∝Number of new product mentionŝ(Average number of comments+average number of likes+average number of retweets+posts velocity) Equation 4

Interim maven score∝Number of deals/offerŝ(Average number of comments+average number of likes+average number of retweets+posts velocity) Equation 5

Further, the system 102 may calculate a high media consumption score of the users by acquiring information from media sources. The media sources may comprise books, newspapers, Television (TV) soaps, news, and movies. The high media consumption score may be calculated based on the following factors:
Number of books mentioned across all the posts
Number of newspapers mentioned across all the posts
Number of TV soaps mentioned across all the posts
Number of times news is shared across all the posts
Number of movies mentioned across all the posts.

Thus equation 6, as mentioned below, may be derived for calculating the high media consumption score.

High media consumption score=Percentage of words associated with the social media Equation 6

Equation 7, as mentioned below, may be used in an embodiment for calculating a maven score.

Maven Score=Psychometric characteristic+High media consumption+Number of connections,*{Number of brandŝa*Number of Productŝb*Number of New Productŝc*Number of Dealŝd} Equation 7

The variables used in the equation 7 have their significances as described henceforth. Here,
a=Average number of comments+Average number of likes+Average number of retweets for posts related to the brand.
b=Average number of comments+Average number of likes+Average number of retweets for posts related to the product.
c=Average number of comments+Average number of likes+Average number of retweets for posts related to the new product.
d=Average Number of comments+Average number of likes+Average number of retweets for posts related to the deals
   In case, number of brands mentioned=0 then, 0̂a=1,
      in case, number of products=0 then, 0̂b=1,
   in case, number of new products=0 then, 0̂c=1, and
      in case, number of deals=0 then, 0̂d=1.

The system 102 may also determine an area of interest factor. The area of interest factor is indicating to the social media users' interest in a specific industry. The area of interest factor may be used as an industry adjustment factor in calculating industry specific maven scores. The area of interest factor of the social media users may base on the following features:
Number of industry specific products talked about
Number of industry specific brands talked about
Number of industry specific jargons talked about

Thus equation 8, as mentioned below, may be used for determining an area of interest factor of the users.

$$Area of interest ∝ \frac{Number of Industry specific Products}{Total number of Products} ( Average number of comments + Average number of Likes + Average number of retweets + Posts velocity ) + \frac{Number of Industry specific Brands}{Total number of Brands} ( Average number of comments + ( Average number of Likes + Average number of retweets + Posts velocity ) + Percentage of Industry specific Jargons \qquad Equation 8$$

In one embodiment, the system 102 may use the area of interest factor of the users, as an industry adjustment factor. The industry adjustment factor may then be used for calculating an industrial maven score of the users. The industrial maven score may be used for identifying the industry specific e-mavens. Equation 9, as mentioned below, may be used for calculating the industrial maven score.

Industrial Maven Score=Psychometric characteristic+High Media Consumption+Industry Adjustment Factor*Number of Connections*{Number of Brandŝa*Number of Productŝb*Number of New Productŝc*Number of Dealŝd} Equation 9

The variables used in the equation 9 have their significances as described henceforth. Here,
a=Average number of comments+Average number of likes+Average number of retweets for posts related to the brand.
b=Average number of comments+Average number of likes+Average number of retweets for posts related to the product.
c=Average number of comments+Average number of likes+Average number of retweets for posts related to the new product.
d=Average Number of comments+Average number of likes+Average number of retweets for posts related to the deals
   In case, number of brands mentioned=0 then, 0̂a=1,
      in case, number of products=0 then, 0̂b=1,
   in case, number of new products=0 then, 0̂c=1, and
      in case, number of deals=0 then, 0̂d=1.

Hence, the industrial maven score, so derived, may be used for ranking the users and thus identifying the e-mavens. The e-mavens identified in this manner may be privileged by the brands, products, or services. The e-mavens may make an effort of publicizing about the brands, products, or services on the social media in a manner as explained here afore.

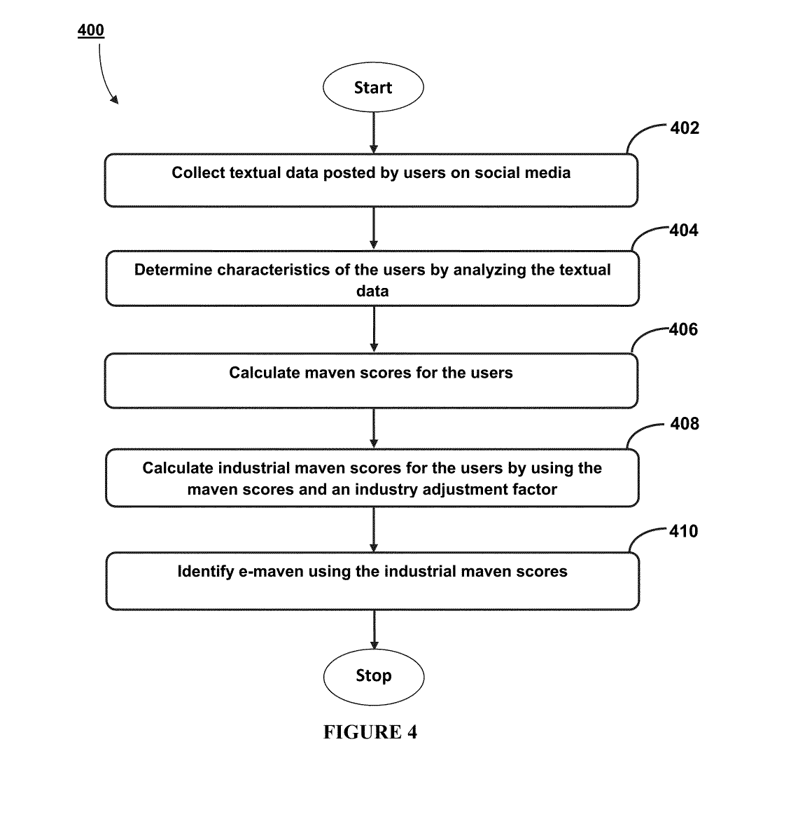

Referring now to FIG. 4, the method for identifying industry specific e-mavens, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented in the above described system 102.

At block 402, textual data posted by users on a social media may be collected. User identification (user ID) may be extracted using the textual data. Further textual data related to the user on other social media may be collected and stored against the user ID. This textual data may further be analyzed.

At block 404, characteristics of the users may be determined by analyzing the textual data. The characteristics may be determined by performing language style and language content analysis of the textual data related to the users. The characteristics may comprise socio-networking characteristics, socio-behavioral characteristics, and psychometric characteristics of the user. The socio-behavioral characteristics may be determined using the socio-behavioral lexical repository 210. Further, the psychometric characteristics may be determined using the psychometric lexical repository 212. In one implementation, the characteristics may be determined by the processor 202.

At block 406, maven scores may be calculated based on the characteristics. The maven scores may be calculated using a set of equations (Equations 1-7). In one implementation, the maven scores may be calculated by the processor 202.

At block 408, industrial maven scores may be calculated using the maven scores and an industry adjustment factor. In one implementation, the industrial maven scores may be calculated by the processor 202, using equations 8 and 9.

At block 410, e-mavens may be identified using the industrial maven scores. The users having a higher value of the industrial maven score may be identified as the industrial e-mavens. In one implementation, the e-mavens may be identified by the processor 202.

Although implementations for methods and systems for identifying an industry specific e-maven by analyzing textual data from social media have been described in language specific to structural features and/or methods, it is to be understood that the appended claims are not necessarily limited to the specific features or methods described. Rather, the specific features and methods are disclosed as examples of implementations for identifying industry specific e-mavens by analyzing textual data from social media.

We claim:

1. A method for identifying an industry specific e-maven by analyzing textual data from social media, said method comprising:
collecting, by a processor, textual data posted by users on social media, wherein the textual data is collected using an industrial corpus, and wherein the industrial corpus comprises a collection of industry specific keywords;
determining, by the processor, characteristics of the users by analyzing the textual data, wherein the textual data is analyzed using an adaptively self-learning database, and wherein the characteristics of the users comprise socio-networking characteristics, socio-behavioral characteristics, and psychometric characteristics;
calculating, by the processor, maven scores for the users, wherein the maven scores are calculated based on the characteristics of the users;
calculating, by the processor, industrial maven scores for the users by using the maven scores and an industry adjustment factor; and
identifying, by the processor, the industry specific e-maven based on the industrial maven scores.

2. The method of claim 1, wherein determining the socio-behavioral characteristics comprises:
searching keywords of the textual data into a socio-behavior lexical repository; and
identifying at least a socio-behavioral characteristic corresponding to the keywords.

3. The method of claim 1, wherein determining the psychometric characteristics comprises:
searching keywords of the textual data into a psychometric lexical repository; and
identifying at least a psychometric characteristic corresponding to the keywords.

4. The method of claim 1, further comprising identifying a new topic from the textual data, wherein the new topic is identified by examining the textual data across online databases.

5. A system for identifying an industry specific e-maven by analyzing textual data from social media, the system comprising:
a processor; and
a memory coupled to the processor, wherein the processor is capable for executing programmed instructions stored in the memory to:
collect textual data posted by a user on social media, wherein the textual data is collected using an industrial corpus, and wherein the industrial corpus comprises a collection of industry specific keywords;
determine characteristics of the users by analyzing the textual data, wherein the textual data is analyzed using an adaptively self-learning database, and wherein the characteristics of the users comprise socio-networking characteristics, socio-behavioral characteristics, and psychometric characteristics;
calculate maven scores for the users, wherein the maven scores are calculated based on the characteristics of the users;
calculate industrial maven scores for the user by using the maven scores and an industry adjustment factor; and
identify the industry specific e-maven based on the industrial maven scores.

6. The system of claim 5, wherein determining the socio-behavioral characteristics comprises:
searching keywords of the textual data into a socio-behavior lexical repository; and
identifying at least a socio-behavioral characteristic corresponding to the keywords.

7. The system of claim 5, wherein determining the psychometric characteristics comprises:
searching keywords of the textual data into a psychometric lexical repository; and
identifying at least a psychometric characteristic corresponding to the keywords.

8. The system of claim 5, further comprising identifying a new topic from the textual data, wherein the new topic is identified by examining the textual data across online databases.

9. The system of claim 5, wherein the users are social media users.

10. A non-transitory computer readable medium embodying a program executable in a computing device for identifying an industry specific e-maven by analyzing data from social media, the program comprising:
a program code for collecting textual data posted by a user on a social media, wherein the textual data is collected using an industrial corpus, and wherein the industrial corpus comprises a collection of industry specific keywords;
a program code for determining characteristics of the users by analyzing the textual data, wherein the textual data is analyzed using an adaptively self-learning database, and wherein the characteristics of the users comprise socio-networking characteristics, socio-behavioral characteristics, and psychometric characteristics;
a program code for calculating maven scores for the users, wherein the maven scores are calculated based on the characteristics of the users;
a program code for calculating industrial maven scores for the user by using the maven scores and an industry adjustment factor; and
identifying the industry specific e-maven based on the industrial maven scores.
